(19) United States
(12) Patent Application Publication
(10) Pub. No.: US 2014/0164143 A1
(43) Pub. Date: Jun. 12, 2014

(54) IMPRESSION TIME UNITS BASED ONLINE ADVERTISEMENT

(71) Applicants: Ofer Zinger, Tel Aviv (IL); Ohad Gliksman, Ramat Gan (IL)

(72) Inventors: Ofer Zinger, Tel Aviv (IL); Ohad Gliksman, Ramat Gan (IL)

(73) Assignee: T.L.V. MEDIA ON LINE LTD, Tel Aviv (IL)

(21) Appl. No.: 14/098,386

(22) Filed: Dec. 5, 2013

Related U.S. Application Data
(60) Provisional application No. 61/734,022, filed on Dec. 6, 2012.

(51) Int. Cl. G06Q 30/02

(52) U.S. Cl. CPC G06Q 30/0273
USPC 705/14.69

(57) ABSTRACT

A computer-implemented method, apparatus and product for impression time units based online advertisement. The computer-implemented method, being performed by a processor or similar computerized device, comprising: having a placement opportunity to be fulfilled; obtaining a plurality of potential advertisements for the placement opportunity, wherein each potential advertisement is associated with at least a proposed impression time unit charge rate and a requested impression time unit allocation; and matching an advertisement from the plurality of potential advertisements to the placement opportunity based on the proposed impression time unit charge rates and requested impression time unit allocations.

### CROSS-REFERENCE TO RELATED APPLICATION

This application claims the benefit of U.S. Provisional Application No. 61/734,022 filed Dec. 6, 2012, entitled “IMPRESSION TIME UNITS BASED ONLINE ADVERTISEMENT”, which is hereby incorporated by reference in its entirety.

### TECHNICAL FIELD

The present disclosure relates to online advertisements in general, and to online advertisement in online web pages, in particular.

### BACKGROUND

According to one definition, advertising is a paid, one-way communication through a medium in which an advertiser may be identified, and the message (i.e., the advertisement or ad) provided by the advertiser is controlled. Advertising may be performed for a variety of purposes, including sales promotion, publicity, public relations, product placement, sponsorship, and underwriting. A variety of mediums are used to convey an advertisement, including television, radio, movies, magazines, newspapers, the Internet, and billboards.

Online Advertising relates to the promoting of products and services using computerized networks such as the Internet and World Wide Web (WWW). Typical online advertisement types include banner ads, floating ads, pop-up ads, and video ads which are provided to a user via the user's computerized device. The user may be browsing websites and in each such website, one or more ads may be displayed. Additionally or alternatively, the ads may be displayed within a component of a website, such as a Flash-based video-player, or the like. Any location in which an ad can be displayed may be referred to as a placeholder.

There are several advertisement compensation models known in the art. A first model is a user action-based compensation model, which includes Cost Per Click (CPC), Click Per Action (CPA), Cost Per Lead (CPL), or the like. In a user action-based compensation model, the compensation by the advertiser to the owner of the placeholder is contingent upon an action by the person to which the advertisement is targeted (also referred to as a user), such as a click, leaving a lead, performing a predetermined action or acquisition within a site of the advertiser, or the like.

A second model is a serving-based compensation model in which the compensation is not dependent on an audience action, but rather on serving the ad and providing it to the audience. The serving-based compensation model includes, for example, Cost Per View (CPV), Cost Per Mille Impression (CPM), or the like.

An “impression” or “ad impression” as used herein and is understood by person of ordinary skill in the art refers to a placement of an advertisement of a campaign in a placeholder for a user. In some exemplary embodiments, each time an ad is served and displayed, it is considered an impression.

### BRIEF SUMMARY

One exemplary embodiment of the disclosed subject matter is a computer-implemented method performed by a computerized device, comprising: determining a number of time units consumed by an advertisement that is displayed in a web page; and computing a compensation to be paid for the advertisement based on the time units and a rate per time unit impression.

Optionally, said determining is based on a load time of the advertisement and removal time of the advertisement.

Optionally, the load time and the removal time are determined by a computer displaying the web page.

Optionally, the computer utilizes a cookie file to store load time.

Optionally, the removal time is determined based on a remove event issued by a browser displaying the web page in response to removing the advertisement.

Another exemplary embodiment of the disclosed subject matter is a computer-implemented method performed by a computerized device, comprising: having a placement opportunity to be fulfilled; obtaining a plurality of potential advertisements for the placement opportunity, wherein each potential advertisement is associated with at least a proposed impression time unit charge rate and a requested impression time unit allocation; and matching an advertisement from the plurality of potential advertisements to the placement opportunity based on the proposed impression time unit charge rates and requested impression time unit allocations.

Optionally, the method also comprises serving the advertisement to a client displaying a web page comprising the placement opportunity.

Optionally, the plurality of potential advertisements is obtained in real-time in a Real-Time Bid (RTB).

Optionally, said matching comprises selecting a potential advertisement associated with the highest proposed impression time unit.

Optionally, said matching comprises estimating a number of impression time units that the placement opportunity will provide, and wherein said matching taking into consideration whether the requested impression time unit allocations is higher than the number of impression time units that the placement opportunity will provide.

Optionally, wherein a first potential advertisement of the plurality of potential advertisements is associated with an action-based compensation model contingent upon an action, and wherein the proposed impression time unit charge rate is an estimated Effective Revenue Per Impression Time Unit and wherein the requested impression time unit allocations is an average time units until the action.

Optionally, wherein a second potential advertisement of the plurality of potential advertisements is associated with compensation model different than the action-based compensation model of the first advertisement, thereby allowing comparison between advertisements associated with different compensation models.

Yet another exemplary embodiment of the disclosed subject matter is a computerized apparatus having a processor, the processor being adapted to perform: having a placement opportunity to be fulfilled; obtaining a plurality of potential advertisements for the placement opportunity, wherein each potential advertisement is associated with at least a proposed impression time unit charge rate and a requested impression time unit allocation; and matching an advertisement from the plurality of potential advertisements to the placement opportunity based on the proposed impression time unit charge rates and requested impression time unit allocations.

Optionally, the processor further adapted to perform serving the advertisement to a client displaying a web page comprising the placement opportunity.

Optionally, the plurality of potential advertisements is obtained in real-time in a Real-Time Bid (RTB).

Optionally, said matching comprises selecting a potential advertisement associated with the highest proposed impression time unit.

Optionally, said matching comprises estimating a number of impression time units that the placement opportunity will provide, and wherein said matching taking into consideration whether the requested impression time unit allocations is higher than the number of impression time units that the placement opportunity will provide.

Optionally, a first potential advertisement of the plurality of potential advertisements is associated with an action-based compensation model contingent upon an action, and wherein the proposed impression time unit charge rate is an estimated Effective Revenue Per Impression Time Unit and wherein the requested impression time unit allocations is an average time units until the action.

Optionally, a second potential advertisement of the plurality of potential advertisements is associated with compensation model different than the action-based compensation model of the first advertisement, thereby allowing comparison between advertisements associated with different compensation models.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIGS. 2A-2B show flowchart diagrams of methods, in accordance with some exemplary embodiments of the disclosed subject matter;

FIG. 3A shows a block diagram of an apparatus, in accordance with some exemplary embodiments of the disclosed subject matter;

FIG. 3B shows a block diagram of an apparatus, in accordance with some exemplary embodiments of the disclosed subject matter; and

FIG. 4 shows an illustration of Effective Revenue Per Impression Time Unit, in accordance with some embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations 5 of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One problem dealt with by the disclosed subject matter is to provide an online advertisement which is capable of discriminating between different time portions during which an impression is provided. In some exemplary embodiments, an impression relating to a first user may have relatively higher value in a time proximate to the load time of a web page, as the first user may be more attentive to advertisement at such time. Additionally or alternatively, a second user may initially focus her attention to non-advertisement content and only later on, the second user may direct her attention to the advertisement. In such a case, the value of the presentation of the advertisement in the initial period may be lower than the value associated with the time when the second user directs her attention to the advertisement.

One technical solution is to track Impression Time Unit (ITU). An ITU may be a time unit in which the impression is provided. As an example, the time unit may be a second, and an impression time unit may be a second in which the impression is provided by placing the ad of the campaign in a placeholder for a user. The time unit may be any time unit, such as but not limited to a second, a millisecond, five seconds, or the like. In some exemplary embodiments, the ITU may refer to a number of impressions such as, for example, mille-impressions.

In some exemplary embodiments, a webpage displaying an impression may be configured to report time units during which the impression was provided. Additionally or alternatively, the webpage may report time in which the impression was revoked, also referred to as “end time”, such as for example due to replacing an ad, due to the user clicking the ad, due to the user browsing to a different webpage, or the like. Based on the time of serving the impression, also referred to as “load time” and the end time, the ITU may be calculated.

In some exemplary embodiments, a number of ITUs for a given impression may be a-priori determined. In some embodiments, the placement of an advertisement for a user in a placeholder may be limited to the number of ITUs. In some exemplary embodiments, upon fulfilling the predetermined number of ITUs allocated to the impression, a new placement opportunity may be generated (for the same placeholder and user, but optionally for a different campaign) and fulfilled. In some exemplary embodiments, a cost of the impression may be based on the number of ITUs.

In some exemplary embodiments, the disclosed subject matter may be limited to refer to Effective ITU (EITU). An Effective ITU is an ITU during which the user was exposed to the impression, such as the impression was visible to the user. In some exemplary embodiments, in case the impression is not visible, such as for example, because the impression is in a location which is not visible due to scrolling, due to the user viewing a different window or tab, or because the user is directing her attention at a different location (which may be determined, for example, based on eye movement tracking), an elapsed time unit is not considered an ITU. In some exemplary embodiments, EITU refers to ITU during which the impression is in a visible space of a web browser. In some exemplary embodiments, the webpage providing the impression may comprise client-side script for tracking the EITU and be configured to report the consumed EITU to a billing server.

In some exemplary embodiments, an ad server may be configured to fulfill impression time placement opportunities. The ad server may be configured to match a campaign to the user and the placement location for a predetermined ITUs. Additionally or alternatively, the ad server may be given a placement opportunity and be configured to match an ad to the placement opportunity and determine a number of ITUs allocated for the ad. After the allocated ITUs have elapsed, the ad server (or a different ad server) may be provided with the placement opportunity to be fulfilled again.

In some exemplary embodiments, an impression that was allocated a predetermined amount of ITUs and did not consume the ITUs, for example, because the user closed the webpage, may not be billed or may be billed with a discount, for the ITUs which were consumed. For example, in case an impression is selected for ten seconds, and assuming the call-to-action is provided at about the end of the ten seconds, it may be decided that in case the ten seconds are not fully consumed, there will be no charge to the advertiser. Additionally or alternatively, it may be determined that for the first three seconds there will be no charge, and for any additional second there will be a reduced charge, such as of 50% the agreed cost of each ITU.

In some exemplary embodiments, the ad server may be a Real-Time Bidding (RTB) Server. The RTB server may implement an auction in which a plurality of bids may be provided. In some exemplary embodiments, the bids may be provided in a predetermined timeframe, such as for example 50 milliseconds. Each bid may include at least a number of ITUs and a cost per ITU. In some exemplary embodiments, the RTB server may implement the bid by selecting the highest bidder for the initial available ITUs. As an example, consider three bids: (1) 10 ITUs at 1¢ per ITU; (2) 5 ITUs at 3¢ per ITU; and (3) 2 ITUs at 4¢ per ITU. The RTB may select the last bid—2 ITUs at 4¢ per ITU—as it provides the highest yield for the first two ITUs (4¢ over 3¢ and 1¢) and although the second bid provides a higher total cost (5×3¢=15¢>8¢=2¢×4¢). In some exemplary embodiments, after the ad of the third bid is placed for 2 ITUs, a second auction may be initiated, in which the same bids and/or different bids may be provided and different selection may optionally be performed.

In some exemplary embodiments, the RTB server may estimate a number of ITUs available in the placement opportunity, such as a user may be estimated to spend a predetermined amount of ITUs at a given webpage based on statistical analysis of historic data, such as browsing history of the user, history of the visitors in the webpage, combination thereof, or the like. The RTB server may base its matching decision on the estimation, such as in case it is estimated that there are 5 ITUs available, a bid of over 5 ITUs may be deemed irrelevant and ignored or may be given a penalty of reducing a computed matching score used for the matching decision.

In some exemplary embodiments, the statistical analysis may be based on historic data relating to fulfillment of placement opportunities that are considered similar to the placement opportunity at hand. The characteristics which may be used to determine similarity between fulfilled placement opportunity may include parameters relating to the user to which the ad is shown (e.g., age, gender, location, socio-economic information, usage history of the web browser, clicking history, average time before click, impression history during a timeframe, such as during the last 24 hours, or the like), parameters relating to the campaign of the ad (e.g., average time until click, average viewing time of the ad, length of a video shown in the ad, type of product being advertised, or the like), parameters relating to the placement (e.g., containing web site, number of banners in the web site, location of the placeholder in the web page, size of the placeholder, clicking history within the web page, web site, placeholder, or the like, visitor statistics of the web site, or the like), or the like.

In some exemplary embodiments, an Effective Revenue Per Impressions Time Unit (ERPITU) of an ad impression may be computed. The ERPITU may be computed based on historic data. In some embodiments, ERPITU may be computed with respect to a placeholder, a user, a campaign, a combination thereof, or the like.

In some embodiments, An ERPITU may be computed with respect to a time unit after loading of the ad to the placeholder. As an example, a first ERPITU value may be computed for the first time unit after any ad is loaded to a given placeholder, and a second an potentially different ERPITU value may be computed for the time unit that follows. The time unit for which the ERPITU is computed may be referred to as a “time unit offset”.

The ERPITU as a function of the time unit offset may be computed to determine expected revenue of each time unit offset. For example, the revenue from the first time unit may be 8¢, the revenue from the second time unit may be 10¢, the revenue from the third time unit may be 12¢, the revenue from the fourth time unit may be 5¢, the revenue from the fifth time unit may be 3¢, and so forth.

The ERPITU may be computed based on historic data, such as all the data, data that is characterized to relate to similar ad impressions based on the placement characteristics and/or campaign characteristics and/or user characteristics and/or other characteristics.

In some exemplary embodiments, ERPITU may be computed for impressions 10 which are associated with a compensation model which is not based on ITUs, such as but not limited to CPA, CPM, CPC, or the like. As an example, in case of an action-based compensation model, the ERPITU may be computed based on an average time to perform the user-action which the ad is contingent upon (e.g., click in a CPC ad). In some exemplary embodiments, the ERPITU may be further computed based on an average time in which the ad impression was displayed and the action was not performed.

Based on the ERPITU matching decision by a matching algorithm may be performed to select between a plurality of alternative ads to fulfill a placement opportunity for a given number of time units. The ERPITU may be used to allow comparison between a CPM ad and a CPC ad. As an example, ERPITU may be computed for a CPC ad by computing a Cost Per Click by a Click Through Rate (CTR) to determine an Effective Cost Per Impression (ECPI). The ECPI may be divided by an average time to unit to click to determine the ERPITU.

In some exemplary embodiments, the ERPITU may be a metric used to estimate efficiency and effectiveness of a campaign.

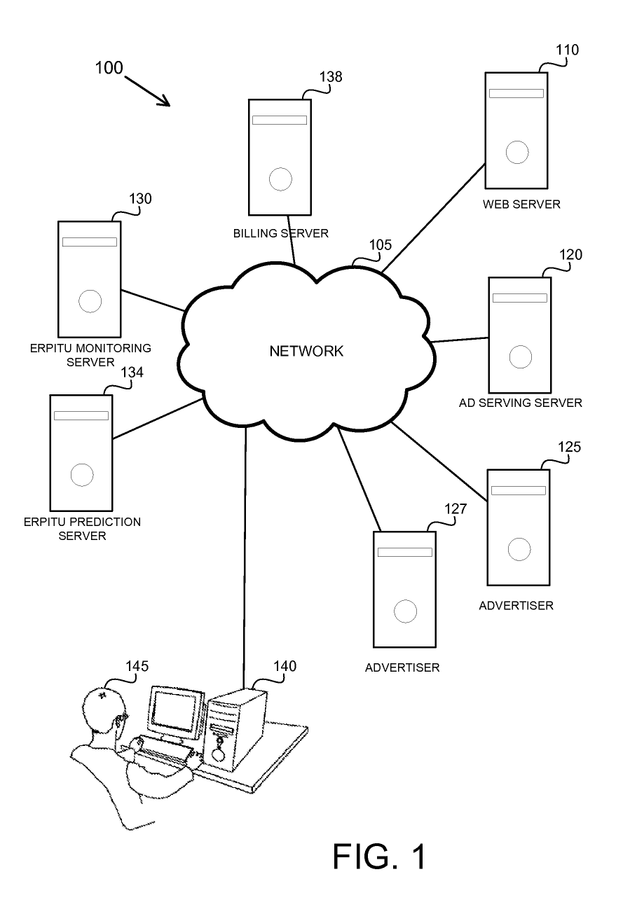

Referring now to FIG. 1 showing a computerized environment 100 in which the disclosed subject matter is used, in accordance with some exemplary embodiments of the subject matter.

A Network 105 of computerized devices, such as a LAN, a WAN, an intranet, the Internet, or the like may be used to connect between different devices. Network 105 may be a wired network, a wireless network, a combination thereof, or the like.

A User 145 may use a Device 140, such as a laptop computer, a mobile device, a smart phone, a desktop computer, or the like. User 145 may browse the WWW or other online content available on Network 105.

In one scenario, User 145 may browse to a web page of a web site, which is hosted on Web Server 110. Web Server 110 may retrieve the web page, such as an HTML file (static file, or a file that is dynamically generated), a Flash file, or the like and transmit the web site to Device 140. The web page may include at least one placeholder.

In some exemplary embodiments, the website may include an HTML tag that is used to instruct Device 140 to provide Ad Serving Server 120 with the placement opportunity. Other methods of providing the placement opportunity may also be used. Ad Serving Server 120 may fulfill the placement opportunity in the placeholder by placing an ad and indicating a predetermined number of ITUs to be allocated for the ad. Upon consuming the predetermined number of ITUs, a placement opportunity may be provided to Ad Serving Server 120, which may fulfill it for the same ad or a different ad.

In some exemplary embodiments, Ad Serving Server 120 may be a computerized server which matches the placement opportunity with the first ad, based on predetermined purchased inventory, such as purchasing a of bulk placements, based on RTB Auction, or the like.

In some exemplary embodiments, Ad Serving Server 120 may be an RTB Server. Upon being notified of a placement opportunity an auction may be initiated in which a plurality of bidders, such as Advertisers 125, 127, may participate. The RTB Server may select an ad from the bids based on a price per ITU, based on number of desired ITUs, combination thereof, or the like. In some embodiments, an ad of the winning bid may be placed in the placement opportunity for a number of ITUs that was requested in the bid.

The web site may include a client-side script, which may be implemented in JavaScript, PHP, Java, or the like, for tracking a number of ITUs elapsed. The elapsed number of ITUs may be used for billing purposes to bill an advertiser based on ITUs consumed. Additionally or alternatively, the elapsed number of ITUs may be used to remove the ad and provide a new placement opportunity for Ad Serving Server 120.

In some exemplary embodiments, the placement opportunity may be passbacked by Ad Serving Server 120, such as when no matching ad is found. The placement opportunity may be provided to another Ad Serving Server which may be given the placement opportunity and which may provide the second ad. During a passback operation, the economic entity which pays for the serving of the ad may change, such that instead of the owner of Ad Serving Server 120 (who may collect the cost from his client), the owner of the other Ad Serving Server (who may collect the cost from her client) may pay for the ad placement.

It will be noted that using the ITU metric as the units to be charged may provide for a more accurate pricing model than other serving-based compensation models, such as CPM. Consider the following scenario: an advertiser may request that his ad be shown for a rate of 1¢ per impression. An owner of a placeholder may place the ad and generate 1¢. However, the owner may also replace the ad after five seconds of being shown and provide the placement opportunity to another advertiser. Thus, the owner generates higher value and reduces the value of the impression of the first advertiser. But the first advertiser's CPM compensation model does not take this adverse behavior into consideration. A compensation model which is based on ITUs takes such behavior into consideration and the reduced value given to the first advertiser correlates with a reduced priced paid by the first advertiser. The ITU metric may further take into account the time in which the ad is visible or otherwise can be perceived by the user. The ITU metric is indifferent to page reloads which may generate a new impression for other serving-based compensation models.

An ERPITU Monitoring Server 130 may be configured to monitor information useful for calculating ERPITU values of each ad impression. The ERPITU may be used as a metric that is useful in online advertising. In some exemplary embodiments, the ERPITU may be computed based on users/campaigns/placeholders that are considered similar to that of the ad impression for which the ERPITU is computed. In some exemplary embodiments, ERPITU may be computed for a user, a campaign, a placeholder, a time unit offset, a combination thereof, or the like.

In some exemplary embodiments, ERPITU Monitoring Server 130 may obtain information relating to users, campaigns, placeholders, time units elapsed, and revenue generated (if generated) from the impression, or the like.

In some exemplary embodiments, client-side script in the web page on Device 140 may be configured to send information to ERPITU Monitoring Server 130. The script may determine load time of the ad, such as based on a load event when the script is initialized. The script may determine the time in which the ad is clicked, such as based on catching a triggered click event when the click is performed. Similarly, the script may determine the time in which any action which the ad compensation is contingent upon is performed. Additionally or alternatively, the script may be responsive to an event which indicates that the ad is being removed or otherwise unloaded, such as an event triggered upon a command to the browser to exit the web page, to close the browser, to browse to a different web page, to remove the advertisement, or the like. Based on catching the removal event, end time may be determined. Based on the difference between end time and load time, ITUs consumed may be computed and the advertiser may be billed. In some embodiments, ERIPTU may be computed based on the aforementioned information.

In some exemplary embodiments, ITUs consumed may be computed by the script by subtracting the load time from the end time. The number of consumed ITUs may be transmitted by the script to ERPITU Monitoring Server 130, to Ad Serving Server 120, to a Billing Server 138, or the like. Additionally or alternatively, the computation may be performed by any of the aforementioned servers themselves, such as based the end time which may be received from Device 140, and based on the load time which may be received from either the Ad Serving Server 120 or from the Device 140.

In one embodiment, Device 140 may store load time information in a cookie file of the browser, and upon detecting ad removal, retrieve the load time information and compute ITUs consumed.

Billing Server 138 may be configured to compute billing information based on ITUs and their agreed cost rates. Billing Server 138 may issue bills to advertisers based on number of ITUs during which ads of the advertisers were served and displayed.

ERPITU Prediction Server 134 may be configured to predict ERPITU of an impression. ERPITU Prediction Server 134 may be configured to determine, based on statistical analysis of relevant historic data, estimation of the ERPITU of an ad, in a placeholder for a user. ERPITU Prediction Server 134 may be utilized to compute estimated ERPITU for ads which are not associated with an ITU-based compensation model. As an example, ERPITU Prediction Server 134 may compute for a CPC ad an estimated ERPITU thereby allowing an ad server, such as Ad Serving Server 120, to select between a CPC ad and another ad. The ERPITU may be used as the metric which is used to compare different ads, even if the ads use different compensation models.

ERPITU Prediction Server 134 may be configured to obtain or compute a Click Through Rate (CTR), a Conversion Rate (CR), or a similar rate of any action-based compensation model, thereby allowing ERPITU Prediction Server 134 to compute Effective Revenue Per Impression (ERPI). ERPI may be used to compute the ERPITU by dividing ERPI by average number of ITU until the action occurs.

ERPITU Prediction Server 134 may be configured to compute ERPITU for an ad associated with a serving based compensation model, such as CPM. ERPITU may be computed by dividing the cost per impression by an average number of ITUs until the ad is removed, such as when the ad is closed, clicked, or the web page is exited.

In some exemplary embodiments, some or all of the servers depicted in FIG. 1, such as but not limited to Ad Serving Server 120, Billing Server 138, ERPITU Monitoring Server 130, ERPITU Prediction Server 134, may be implemented as a single server.

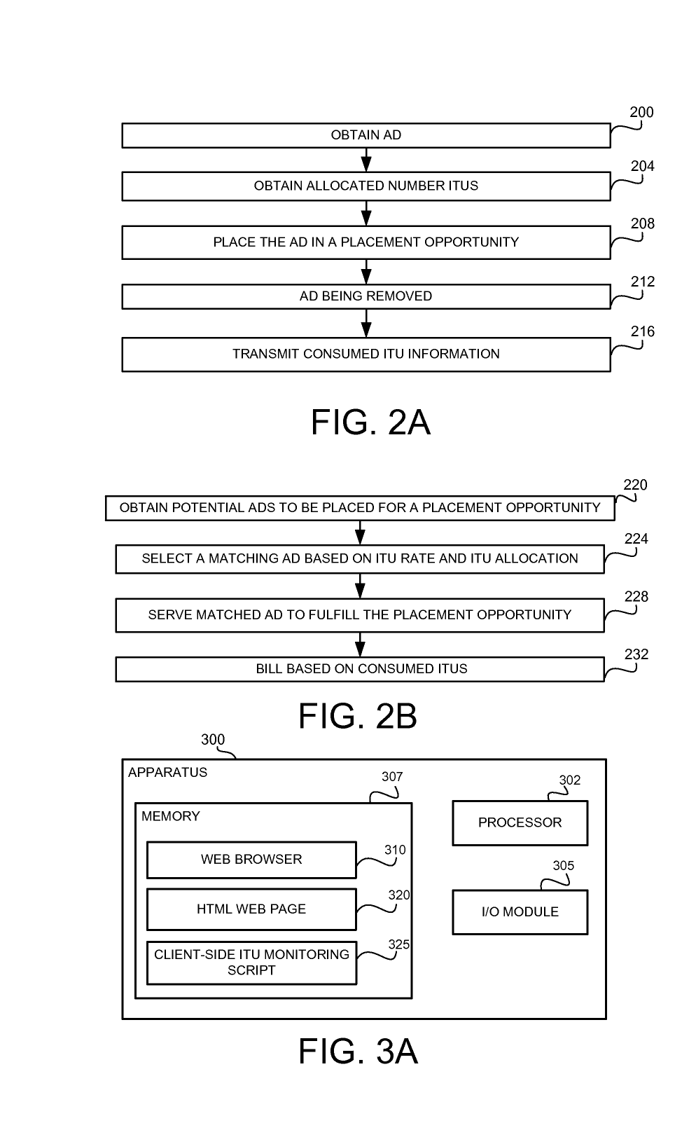

Referring now to FIG. 2A showing a flowchart diagram of steps in a method performed by a client device, such as Device 140 of FIG. 1, in accordance with some embodiments of the disclosed subject matter.

In Step 200, an ad to be placed in a placeholder of a webpage displayed to the user of the client device is obtained. The ad may be obtained from an ad server, an RTB server, or the like.

In Step 204, an allocated number of ITUs for the ad may be obtained. The allocated number of ITUs may be based on a decision by a campaign manager of the ad which may be based on the type of ad, such as a video ad, a banner, or the like, and an estimated time of perception of the advertisement by an audience. Additionally or alternatively, the number of ITUs may be provided by a prediction server, such as 134 of FIG. 1. The prediction server may predict average number of ITUs until a relevant action is performed, and provide the number of ITUs.

In Step 208, the ad may be placed in the placeholder to fulfill the placement opportunity. The load time of the ad may be determined and optionally stored in a cookie file.

In Step 212, the ad may be removed. The ad may be removed because of a user action, such as but not limited to browsing to a different web page, closing the ad, closing a web browser being used to display the ad, refreshing the web page, or the like. Additionally or alternatively, the ad may be removed in response to consuming all allocated ITUs. The client device may track ITUs consumed by tracking a time in which the ad is displayed. After consuming all a-priori allocated ITUs, the ad may be removed.

In Step 216, consumed ITU information is transmitted to a server. The consumed ITU may be transmitted to a billing server to enable billing based on a rate per ITU. In some exemplary embodiments, ITU information relating only to EITU may be transmitted thereby billing only with respect to ITU during which the impression was in a visible space of the browser and visible to the user. Additionally or alternatively, the consumed ITU may be transmitted to an ERPITU monitoring server in order to provide for statistical information for computing ERPITU of the impression or any entity associated thereto, such as the user, the campaign, and the placeholder.

In some exemplary embodiments, in response to the ad being removed due to consumption of the allocated ITUs, a new placement opportunity may be provided. The new placement opportunity may be fulfilled by an ad having the same or a different number of allocated ITUs.

Referring now to FIG. 2B showing a flowchart diagram of steps in a method, in accordance with an embodiment of the disclosed subject matter.

In Step 220, potential ads to be placed with respect to a placement opportunity may be obtained. The ads may be obtained from bidders in an RTB auction. Additionally or alternatively, the ads may be obtained from an offline repository of ads of an ad server. In some exemplary embodiments, each potential ad may be associated with an offered cost per ITU (“ITU rate”) and requested allocated ITUs.

In some exemplary embodiments, an ad may be associated with different ITU rates for different time offsets, such as a first high ITU rate for a first period, a second lower ITU rate for the period that follows, and a rate of zero ITU rate (i.e., no cost) for any additional ITU.

In Step 224, a matching ad may be selected for the placement opportunity. The matching ad may be selected based on the ITU rate and/or based on the requested allocated ITUs for the ad. In some exemplary embodiments, the ad having the highest ITU rate may be selected. Additionally or alternatively, the ad having the highest total yield may be selected, such as for example, based on an estimation of the ITUs of the placement opportunity. The selection may be performed using a matching algorithm taking into consideration characteristics of the user, the campaign, the placeholder, and the like.

In Step 228, the matching ad may be served in order to fulfill the placement opportunity. The matching ad may be transmitted to the client device to be displayed. The client device may obtain the ad, such as described in Step 200. Additionally or alternatively, the allocated ITU may be transmitted to the client device, which may obtain in Step 204.

In Step 232, a consumed number of ITUs by the ad may be used to compute a cost of the fulfilled placement. The consumed number of ITUs may be obtained from the client device, such as from the information transmitted in Step 216. In some exemplary embodiments, the cost may be computed by multiplying the consumed ITUs by their respective ITU rate. Based on the cost, the advertiser associated with the ad may be billed.

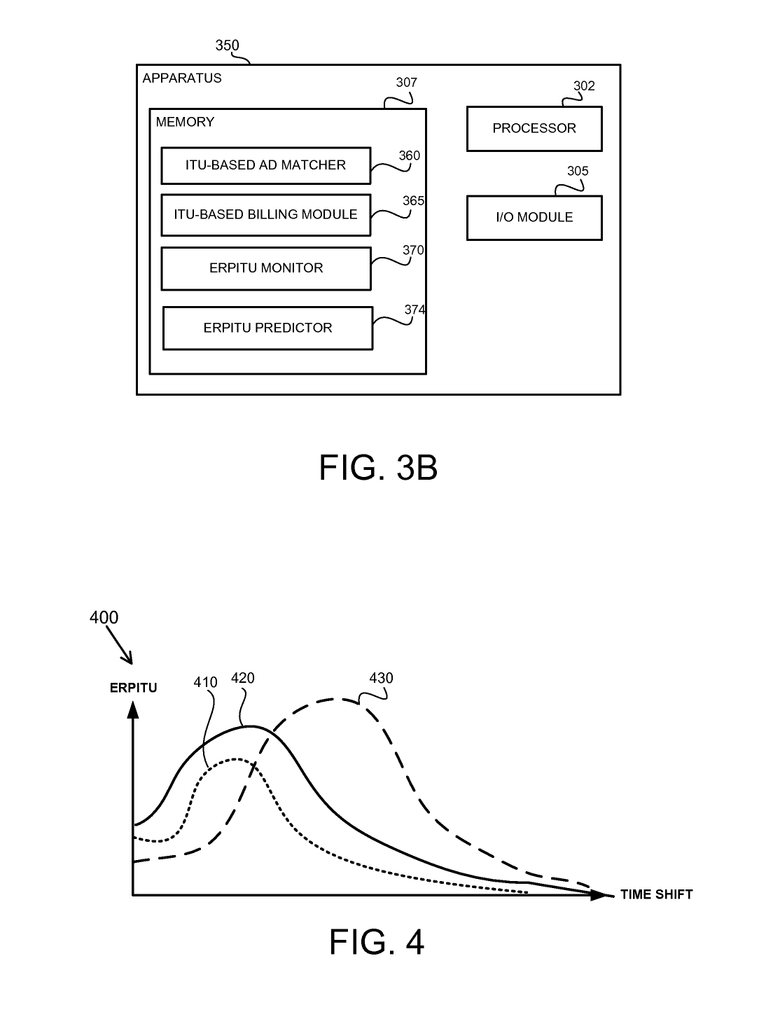

Referring now to FIGS. 3A-3B showing block diagrams of apparatuses, in accordance with some exemplary embodiments of the disclosed subject matter.

In some exemplary embodiments, Apparatus 300 and/or 350 may comprise a Processor 302. Processor 302 may be a Central Processing Unit (CPU), a microprocessor, an electronic circuit, an Integrated Circuit (IC) or the like. Processor 302 may be utilized to perform computations required by Apparatus 300, 350 or any of it subcomponents.

In some exemplary embodiments of the disclosed subject matter, Apparatus 300, 350 may comprise an Input/Output (I/O) module 305. I/O module 305 may be utilized to provide output to and receive input from a user, an administrator, a placeholder owner, or the like. In some exemplary embodiments, I/O Module 305 may provide an interface to a computerized network, such as 105 of FIG. 1.

In some exemplary embodiments, Apparatus 300, 350 may comprise a Memory Unit 307. Memory Unit 307 may be a short-term storage device or long-term storage device. Memory Unit 307 may be a persistent storage or volatile storage. Memory Unit 307 may be a disk drive, a Flash disk, a Random Access Memory (RAM), a memory chip, or the like. In some exemplary embodiments, Memory Unit 307 may retain program code operative to cause Processor 302 to perform acts associated with any of the subcomponents of Apparatus 300, 350. In some exemplary embodiments, Memory Unit 307 may retain program code operative to cause Processor 302 to perform acts associated with any of the steps in FIG. 2A-2B above.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

Referring first to components of Memory Unit 307 of Apparatus 300 that may 25 function as a client device, such as 140 of FIG. 1.

A Web Browser 310 may be configured to obtain web pages from servers in a computerized network, such as HTML Web Page 320. In response to obtaining HTML Web Page 320, it may be retained in Memory Unit 307. Web Browser 310 may be configured to render HTML Web Page 320 and provide a display thereof such as a graphical display, to a user. In some exemplary embodiments, Web Browser 310 may be configured to cause execution of client-side scripts, such as Client-Side ITU Monitoring Script 325, in accordance with instructions embedded in or otherwise associated with the HTML Web Page 320.

HTML Web Page 320 may comprise the placeholder. The placeholder may be implemented as an HTML tag which is configured to invoke a placement opportunity 5 request at an ad server, such as 120 of FIG. 1.

Client-Side ITU Monitoring Script 325 may be configured to track ITU consumption. Script 325 may be configured to track a number of consumed ITUs in order to determine whether the a-priori allocated ITUs have been consumed. In response to such estimation, Script 325 may remove the ad and invoke a second 10 placement opportunity for the placeholder.

Client-Side ITU Monitoring Script 325 may be configured to transmit ITU consumption information to remote servers, such as but not limited to ERPITU Monitoring Server 130, Ad Serving Server 120, billing server, or the like. The transmitted information may be used for calculating values for ERIPTU metrics, for 15 billing purposes, for statistical analysis, or the like.

Referring now to components of Memory Unit 307 of Apparatus 350 that may function as a server, such as 120, 130 of FIG. 1.

ITU-Based Ad Matcher 360 may be configured to select a matching ad for a placement opportunity based on an ITU rate of potentials ads.

ITU-Based Billing Module 365 may be configured to compute a cost of an impression that was provided based on the ITU rate and the number of ITUs that were consumed by the impression.

ERPITU Monitor 370 may be configured to obtain consumed ITU information to compute values for ERPITU metrics associated with the impression, the user, the campaign, the placeholder, the time offset, or the like.

ERPITU Predictor 374 may be configured to predict ERPITU of an ad which is not associated with an ITU rate. ERPITU Predictor 374 may be configured to utilize monitored information of ERPITU Monitor 370 to determine the estimated ERPITU. ERPITU Predictor 374 may track or obtain CTR and CR relevant to action-based compensation models to allow computation of ERPITU of ads associated with action-based compensation models. ERPITU Predictor 374 may track or obtain average click time, average action time, average end time, or the like to compute average ITU of an ad in order to calculate the estimated ERPITU. In one embodiment, ERPITU of an action-based compensation model may be computed as follows:

$$E R I P T U = \frac{C \cdot C T R \cdot C R}{I T U} ,$$

where C is a cost per conversion, CTR is a click through rate, CR is a conversion rate when the ad is clicked and ITU is an average number of ITUs during which the ad is displayed. In a CPC compensation model, C may be 100% as each click is considered as a conversion. Additionally or alternatively, ERIPTU may be computed based on a conversion rate indicating a portion of conversions when the ad is served.

Referring now to FIG. 4 showing an Illustration 400 of the ERPITU as a function of time offset, in accordance with some exemplary embodiments of the disclosed subject matter. The first time unit on the time scale relates to the first time unit after the ad impression is displayed. The second time unit relates to the time unit that follows and so forth. As can be appreciated, the ERPITU may differ in different time offsets.

Charts 410, 420, 430 may each be related to a different ad impression, which may differ from one another in user characteristics, campaign characteristics, placement characteristics, a combination thereof, or the like. As a non-limiting example, Chart 410, 420, 430 may relate to the same ad, in the same placeholder but for a different user.

In some exemplary embodiments, some charts may have a decreasing trend from a certain point in time. This may be because that after some point, it is less and less likely that the user will perform the action (e.g., click). In some exemplary embodiments, initially there may be an increasing trend due to the fact that the ad may require the user some time to comprehend the message, to fully view the ad (e.g., view the video or slideshow), or the like.

Non-provisional patent application Ser. No. 13/668,413 entitled “Method and System for Advertisement Replacement” filed Nov. 5, 2012, is hereby incorporated by reference in its entirety.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a computerized device, comprising:
determining a number of time units consumed by an advertisement that is displayed in a web page; and
computing a compensation to be paid for the advertisement based on the time units and a rate per time unit impression.

2. The method of claim 1, wherein said determining is based on a load time of the advertisement and removal time of the advertisement.

3. The method of claim 2, wherein the load time and the removal time are determined by a computer displaying the web page.

4. The method of claim 3, wherein the computer utilizes a cookie file to store load time.

5. The method of claim 3, wherein the removal time is determined based on a remove event issued by a browser displaying the web page in response to removing the advertisement.

6. A computer-implemented method performed by a computerized device, comprising:
having a placement opportunity to be fulfilled;
obtaining a plurality of potential advertisements for the placement opportunity, wherein each potential advertisement is associated with at least a proposed impression time unit charge rate and a requested impression time unit allocation; and
matching an advertisement from the plurality of potential advertisements to the placement opportunity based on the proposed impression time unit charge rates and requested impression time unit allocations.

7. The computer-implemented method of claim 6, further comprising serving the advertisement to a client displaying a web page comprising the placement opportunity.

8. The computer-implemented method of claim 6, wherein the plurality of potential advertisements is obtained in real-time in a Real-Time Bid (RTB).

9. The computer-implemented method of claim 6, wherein said matching comprises selecting a potential advertisement associated with the highest proposed impression time unit.

10. The computer-implemented method of claim 6, wherein said matching comprises estimating a number of impression time units that the placement opportunity will provide, and wherein said matching taking into consideration whether the requested impression time unit allocations is higher than the number of impression time units that the placement opportunity will provide.

11. The computer-implemented method of claim 6, wherein a first potential advertisement of the plurality of potential advertisements is associated with an action-based compensation model contingent upon an action, and wherein the proposed impression time unit charge rate is an estimated Effective Revenue Per Impression Time Unit and wherein the requested impression time unit allocations is an average time units until the action.

12. The computer-implemented method of claim 11, wherein a second potential advertisement of the plurality of potential advertisements is associated with compensation model different than the action-based compensation model of the first advertisement, thereby allowing comparison between advertisements associated with different compensation models.

13. A computerized apparatus having a processor, the processor being adapted to perform:
having a placement opportunity to be fulfilled;
obtaining a plurality of potential advertisements for the placement opportunity, wherein each potential advertisement is associated with at least a proposed impression time unit charge rate and a requested impression time unit allocation; and
matching an advertisement from the plurality of potential advertisements to the placement opportunity based on the proposed impression time unit charge rates and requested impression time unit allocations.

14. The apparatus of claim 13, wherein the processor further adapted to perform serving the advertisement to a client displaying a web page comprising the placement opportunity.

15. The apparatus of claim 13, wherein the plurality of potential advertisements is obtained in real-time in a Real-Time Bid (RTB).

16. The apparatus of claim 13, wherein said matching comprises selecting a potential advertisement associated with the highest proposed impression time unit.

17. The apparatus of claim 13, wherein said matching comprises estimating a number of impression time units that the placement opportunity will provide, and wherein said matching taking into consideration whether the requested impression time unit 10 allocations is higher than the number of impression time units that the placement opportunity will provide.

18. The apparatus of claim 13, wherein a first potential advertisement of the plurality of potential advertisements is associated with an action-based compensation model contingent upon an action, and wherein the proposed impression time unit charge rate is an estimated Effective Revenue Per Impression Time Unit and wherein the requested impression time unit allocations is an average time units until the action.

19. The apparatus of claim 18, wherein a second potential advertisement of the plurality of potential advertisements is associated with compensation model different than the action-based compensation model of the first advertisement, thereby allowing comparison between advertisements associated with different compensation models.
